(19) United States
(12) Patent Application Publication
(10) Pub. No.: US 2025/0292348 A1
(43) Pub. Date: Sep. 18, 2025

(54) LINEAR ATTENTION SEQUENCE PARALLELISM METHOD AND APPARATUS, DEVICE, AND MEDIUM

(71) Applicant: SHANGHAI ARTIFICIAL INTELLIGENCE INNOVATION CENTER, Shanghai (CN)

(72) Inventors: Weigao SUN, Shanghai (CN); Yiran ZHONG, Shanghai (CN); Zhen QIN, Shanghai (CN); Dong LI, Shanghai (CN); Xuyang SHEN, Shanghai (CN)

(21) Appl. No.: 18/767,581

(22) Filed: Jul. 9, 2024

(30) Foreign Application Priority Data
Mar. 14, 2024 (CN) 202410293061.5

(51) Int. Cl. G06T 1/20; G06F 9/38

(52) U.S. Cl. CPC G06T 1/20; G06F 9/3885

(57) ABSTRACT

A linear attention sequence parallelism method includes distributing, by a first processing device, each of multiple subsequences corresponding to an original sequence in a distributed environment to a respective one of multiple second processing devices according to a data distribution strategy; determining, by the respective second processing device, a respective one of multiple forward total output matrices corresponding to each subsequence according to a preconfigured forward propagation manner; and determining, by the respective second processing device, a respective one of multiple parameter gradients corresponding to each subsequence according to a preconfigured backpropagation manner and the forward total output matrix, and updating a parameter corresponding to each subsequence according to the respective parameter gradient.

### CROSS-REFERENCE TO RELATED APPLICATION

This application claims the priority to Chinese Patent Application No. CN2024102930615, filed on Mar. 14, 2024, the disclosure of which is incorporated herein by reference in its entirety.

### TECHNICAL FIELD

The present disclosure relates to the field of artificial intelligence technologies and, in particular, to a linear attention sequence parallelism method and apparatus, a device, and a medium.

### BACKGROUND

Sequence parallelism (SP) method is a common strategy for processing long sequences that exceed the memory limit of a single graphics processing unit (GPU). However, the existing SP method does not fully utilize the linear attention properties, resulting in poor parallel efficiency and poor usability of linear attention-based language models.

### SUMMARY

The present disclosure provides a linear attention sequence parallelism (SP) method and apparatus, a device, and a medium to solve the technical problem in the related art that the memory is limited when a single device is used to calculate a very long sequence.

According to an aspect of the present disclosure, a linear attention sequence parallelism method is provided and includes the steps described below.

A first processing device distributes multiple subsequences corresponding to an original sequence on a linear transformer in a distributed environment to corresponding second processing devices according to a preconfigured data distribution strategy.

A second processing device of the corresponding second processing devices determines a forward total output matrix corresponding to a subsequence of the multiple subsequences according to a preconfigured forward propagation method.

The second processing device determines a parameter gradient corresponding to the subsequence according to a preconfigured backpropagation manner and the forward total output matrix and updates a parameter corresponding to the subsequence according to the parameter gradient.

According to another aspect of the present disclosure, a linear attention sequence parallelism apparatus is provided and includes a distribution module, a first determination module, and a second determination module.

The distribution module is configured in a first processing device and to distribute multiple subsequences corresponding to an original sequence on a linear transformer in a distributed environment to corresponding second processing devices according to a preconfigured data distribution strategy.

The first determination module is configured in a second processing device of the corresponding second processing device and to determine a forward total output matrix corresponding to a subsequence of the multiple subsequences according to a preconfigured forward propagation manner.

The second determination module is configured in the second processing device and to determine a parameter gradient corresponding to the subsequence according to a preconfigured backpropagation manner and the forward total output matrix and is configured to update a parameter corresponding to the subsequence according to the parameter gradient.

According to another aspect of the present disclosure, an electronic device is provided and includes at least one processor and a memory communicatively connected to the at least one processor.

The memory stores a computer program executable by the at least one processor to enable the at least one processor to perform the linear attention sequence parallelism method according to any embodiment of the present disclosure.

According to another aspect of the present disclosure, a computer-readable storage medium is provided. The computer-readable storage medium is configured to store computer instructions configured to, when executed by a processor, cause the processor to perform the linear attention sequence parallelism method according to any embodiment of the present disclosure.

In the technical solution of the embodiment of the present disclosure, a first processing device distributes multiple subsequences corresponding to an original sequence on a linear transformer in a distributed environment to corresponding second processing devices according to a preconfigured data distribution strategy; a second processing device of the corresponding second processing devices determines a forward total output matrix corresponding to a subsequence of the multiple subsequences according to a preconfigured forward propagation manner; and the second processing device determines a parameter gradient corresponding to the subsequence according to a preconfigured backpropagation manner and the forward total output matrix and updates a parameter corresponding to the subsequence according to the parameter gradient. In the technical solution of the present disclosure, a relatively long original sequence is divided into the multiple subsequences through the preconfigured data distribution strategy, the multiple subsequences are distributed to the corresponding second processing devices to achieve the process of distributed processing, and intermediate states are exchanged within multiple second processing devices or between the multiple second processing devices in forward propagation and backpropagation processes so that the processing efficiency of the sequences can be improved, thereby making the implementation more hardware-friendly on a cluster of second processing devices.

It is to be understood that the content described in this part is neither intended to identify key or important features of embodiments of the present disclosure nor intended to limit the scope of the present disclosure. Other features of the present disclosure are apparent from the description provided hereinafter.

### BRIEF DESCRIPTION OF DRAWINGS

To illustrate the technical solutions of the embodiments of the present disclosure more clearly, the drawings used in the description of the embodiments are described briefly hereinafter. Apparently, the drawings described below illustrate merely part of the embodiments of the present disclosure. Those of ordinary skill in the art may obtain other drawings based on these drawings on the premise that no creative work is done.

FIG. 1 is a flowchart of a linear attention sequence parallelism method according to some embodiments of the present disclosure;

FIG. 2 is a visual block diagram of linear attention sequence parallelism (LASP) according to some embodiments of the present disclosure;

FIG. 3 is a flowchart of another linear attention sequence parallelism method according to some embodiments of the present disclosure;

FIG. 4 is a flowchart illustrating the implementation of data distribution according to some embodiments of the present disclosure;

FIG. 5 is an example diagram of data distribution in LASP according to some embodiments of the present disclosure;

FIG. 6 is a flowchart illustrating the implementation of a forward propagation method according to some embodiments of the present disclosure;

FIG. 7 is a flowchart illustrating the implementation of a backpropagation method according to some embodiments of the present disclosure;

FIG. 8 is a structural diagram of a linear attention sequence parallelism apparatus according to some embodiments of the present disclosure; and

FIG. 9 is a block diagram of an electronic device according to some embodiments of the present disclosure.

### DETAILED DESCRIPTION

For a better understanding of the solutions of the present disclosure by those skilled in the art, the technical solutions in the embodiments of the present disclosure are described clearly and completely below in conjunction with the drawings in the embodiments of the present disclosure. Apparently, the embodiments described below are merely part, not all, of the embodiments of the present disclosure. Based on the embodiments of the present disclosure, all other embodiments obtained by those of ordinary skill in the art on the premise that no creative work is done are within the scope of the present disclosure.

It is to be noted that the terms “first”, “second”, and the like in the description, claims, and drawings of the present disclosure are used for distinguishing between similar objects and are not necessarily used for describing a particular order or sequence. It is to be understood that the data used in this manner is interchangeable in appropriate cases so that the embodiments of the present disclosure described herein may be implemented in a sequence not illustrated or described herein. Additionally, terms “including” and “having” as well as any variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

The present disclosure designs an efficient point-to-point communication mechanism and uses the right-product kernel trick of linear attention to greatly reduce the communication overhead of SP. The practical efficiency of LASP can be improved by performing kernel fusion and intermediate state caching, thereby making the implementation of LASP more hardware-friendly on a GPU cluster. In addition, compatibility of sequence-level LASP with all types of batch-level data parallel methods can be ensured in detail, which is critical for distributed training on large clusters with long sequences and large batches. Extensive experiments are conducted on two linear attention-based models, covering different sequence lengths and GPU cluster sizes. Using a 1B model with 128 A100 80G GPUs, LASP can extend the sequence length to 4096 K, which is eight times longer than that in the existing SP method while the speed is greater.

In the present disclosure, the LASP technology suitable for a linear transformer is proposed to achieve efficient SP. The method includes a complex communication mechanism based on point-to-point communication and is used for exchanging intermediate states in forward transmission and backward transmission processes within a node or among multiple nodes. This design maximizes the utilization of the right-product kernel trick in linear attention. It is to be noted that the technology does not rely on partitioning of attention heads, making the technology to be applied to models with different numbers or styles of attention heads, such as multi-head attention, multi-query attention, and grouped query attention. This flexibility exceeds the capabilities of SP methods in existing Megatron-LM or DeepSpeed.

Moreover, LASP implementation adopts system engineering optimizations, such as kernel fusion and key-value (KV) state caching, thereby significantly improving execution efficiency. In addition, during the implementation, the compatibility of LASP with various (sharded) distributed data parallel (DDP) training methods can be ensured and referred to as data- sequence hybrid parallelism. Extensive experiments on linear transformer models with different numbers of parameters, cluster sizes, and sequence lengths demonstrate the excellent performance and efficiency of LASP when LASP is used with these DDP instances. Specifically, LASP is much faster than the existing SP method and can extend the sequence length by eight times under the same hardware constraints.

A new SP strategy for linear attention is used in the embodiment of the present disclosure. In this manner, linear attention-based models can scale for long sequences without being limited by a single GPU. The new SP strategy has the following advantages.

The communication overhead is independent of the sequence length. The elegant communication mechanism utilizes the right-product kernel trick of linear attention to ensure that the exchange of intermediate states of linear attention is independent of the sequence length.

GPU-friendly implementation is ensured. Through meticulous system engineering optimizations, including kernel fusion and KV state caching, the execution efficiency of LASP on the GPU is optimized.

Compatibility with data parallelism is ensured. LASP is compatible with all batch-level DDP methods, such as PyTorch/Legacy DDP, the fully sharded data parallel (FSDP), and the zero redundancy optimizer (ZeRO).

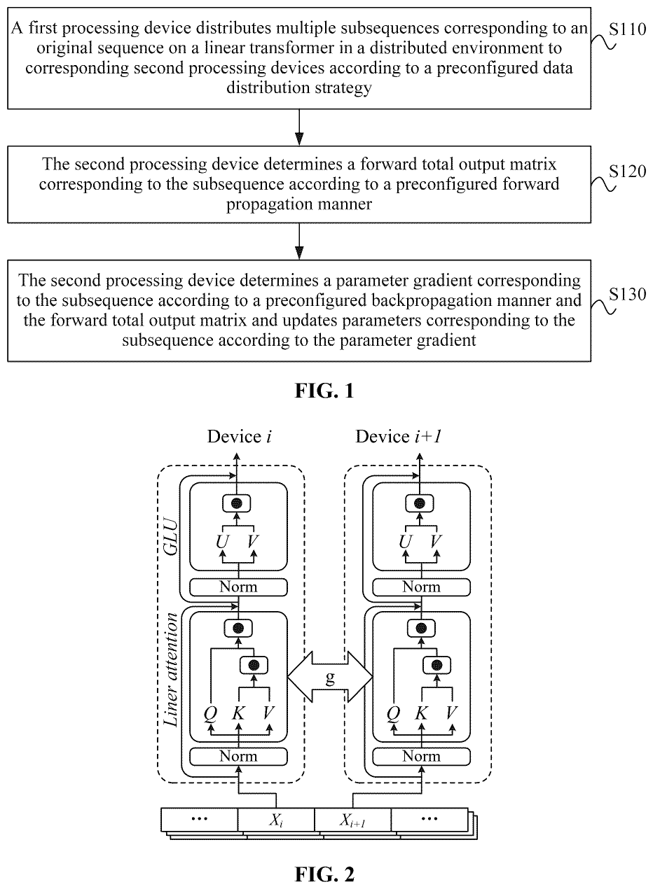

FIG. 1 is a flowchart of a linear attention sequence parallelism method according to some embodiments of the present disclosure. These embodiments may be applied to the case of processing very long sequences. The method may be performed by a linear attention sequence parallelism apparatus. The linear attention sequence parallelism apparatus may be implemented in the form of hardware and/or software and may be configured in an electronic device. For example, the electronic device may include a computer, an iPad, a tablet computer, and other terminal devices with a data processing function. In this embodiment, LASP slices the sequence on the cluster. Following the idea of slicing, LASP divides the input sequence into multiple subsequence blocks and allocates these blocks to different GPUs. For the application of linear attention in informal settings, to take full advantage of the right multiplication in linear attention, the attention calculation of subsequences may be divided into two different types: intra-blocks and cross-blocks. Intra-blocks involve conventional attention calculations, while cross-blocks adopt kernel tricks related to the right multiplication of linear attention. FIG. 2 is a visual block diagram of LASP according to some embodiments of the present disclosure. To provide more detailed information, the complex mechanism of LASP in terms of data distribution, forward propagation, and backpropagation is explained. FIG. 2 shows the visualization effect of LASP and further deepens the understanding of LASP. As shown in FIG. 2, a first processing device and a second processing device (which may be referred to as discrete devices) may be included. For example, the first processing device may be a central processing unit (CPU), and the second processing device may be a GPU (which may be referred to as a Device). As shown in FIG. 2, two adjacent GPUs are device i and device i+1, respectively, each Device includes linear attention, a gated linear unit (GLU) activation function, and two normalization layers (Norm), and two subsequences Xᵢ and Xᵢ₊₁ are distributed to device i and device i+1 respectively.

A typical linear transformer layer is used as an example to describe the LASP mechanism. It is assumed that the inputted original sequence X is divided into multiple subsequence blocks Xᵢ, and the multiple subsequence blocks Xᵢ are then fed back to different model copies in different second processing devices. g represents the conjugate communication operation in forward propagation and backpropagation. In forward propagation, g is the Send and Recv operations from device i to device i+1; and in backpropagation, g is the Send and Recv operations from device i+1 to device i. The communication operation exchanges the forward intermediate state KV and the reverse intermediate state dKV in forward propagation and backpropagation processes to ensure sequence parallelism performance. As shown in FIG. 1, the method includes the steps described below.

In S110, a first processing device distributes multiple subsequences corresponding to an original sequence on a linear transformer in a distributed environment to corresponding second processing devices according to a preconfigured data distribution strategy.

The data distribution strategy is used for dividing the original sequence into multiple subsequences and distributing the multiple subsequences to the corresponding second processing devices. In some embodiments, a distributed environment may be understood as a communication group, the communication group may include one first processing device and multiple second processing devices, and the number of second processing devices included in the communication group is the same as the number of subsequences. It may also be understood as dividing the original sequence according to the number of second processing devices included in the communication group to obtain multiple subsequences whose number is the same as the number of second processing devices. The original sequence may be understood as a sequence with a very long sequence length, and memory limitations are prone to occur when one second processing device is used for processing the original sequence.

In S120, the second processing device determines a forward total output matrix corresponding to the subsequence according to a preconfigured forward propagation manner.

The forward total output matrix may be understood as a matrix generated using the preconfigured forward propagation manner. The forward total output matrix is used for evaluating the loss function of a linear attention model in the second processing device. In some embodiments, the forward total output matrix is related to the parameters corresponding to each subsequence. For example, the parameters may include a total query matrix, a total keyword matrix, and a total numerical matrix. The preconfigured forward propagation method may be used to calculate multiple parameters, so as to obtain the corresponding forward total output matrix.

In S130, the second processing device determines a parameter gradient corresponding to the subsequence according to a preconfigured backpropagation manner and the forward total output matrix and updates parameters corresponding to the subsequence according to the parameter gradient.

A parameter gradient refers to a gradient of different parameters corresponding to each subsequence. In the case where the parameters include the total query matrix, the total keyword matrix, and the total numerical matrix, correspondingly, the parameter gradients may include the gradient of the total query matrix, the gradient of the total keyword matrix, and the gradient of the total numerical matrix. In some embodiments, the preconfigured backpropagation method may be used to calculate multiple parameters and the gradient of the forward total output matrix to obtain the corresponding parameter gradients, so as to update the parameters corresponding to the subsequence according to the parameter gradients.

In the technical solution of this embodiment, a relatively long original sequence is divided into the multiple subsequences through the preconfigured data distribution strategy, the multiple subsequences are distributed to the corresponding second processing devices to achieve the process of distributed processing, and intermediate states are exchanged within multiple second processing devices or between the multiple second processing devices in forward propagation and backpropagation processes so that the processing efficiency of the sequences can be improved, thereby making the implementation more hardware-friendly on a cluster of second processing devices.

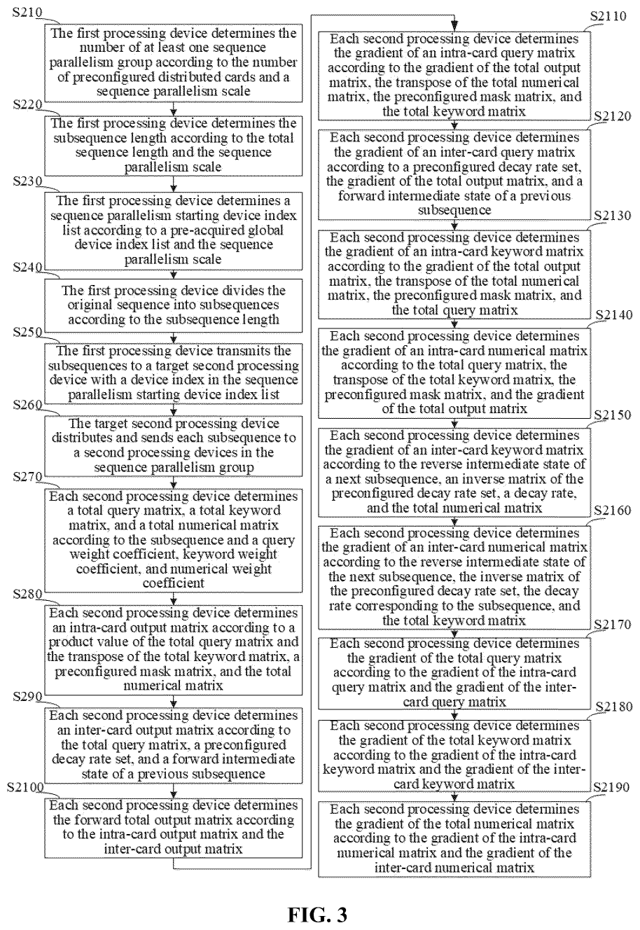

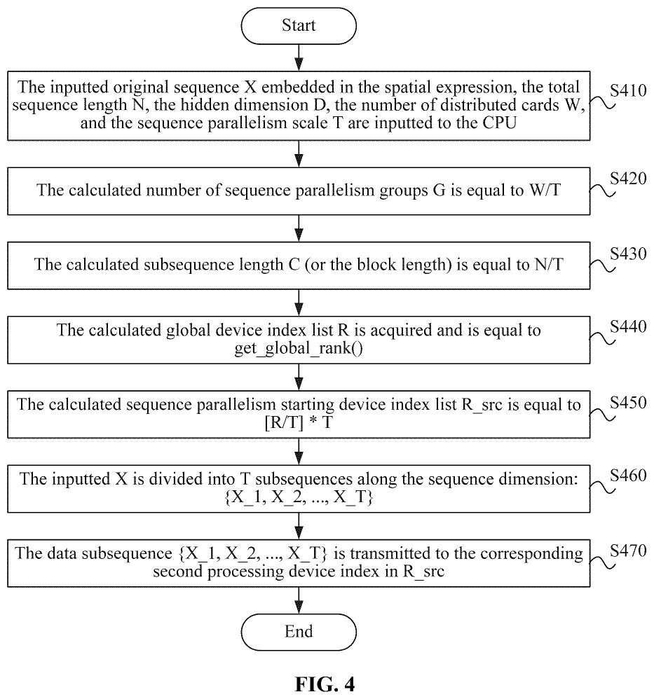

FIG. 3 is a flowchart of another linear attention sequence parallelism method according to some embodiments of the present disclosure. Based on the preceding embodiment, this embodiment describes the implementation process of data distribution, forward propagation, and backpropagation. As shown in FIG. 3, the method includes the steps described below.

In S210, the first processing device determines the number of at least one sequence parallelism group according to the number of preconfigured distributed cards and a sequence parallelism scale.

The number of distributed cards may also be referred to as the distributed world size and be used for representing the number of second processing devices included in one communication group. The sequence parallelism scale refers to the number of at least one subsequence into which one original sequence is divided, and the value of the sequence parallelism scale needs to be evenly divisible by the number of distributed cards. The number of the at least one sequence parallelism group refers to the total number of at least one sequence parallelism group included in one communication group. In some embodiments, the ratio of the number of distributed cards to the sequence parallelism scale may be used as the number of the at least one sequence parallelism group.

In S220, the first processing device determines the subsequence length corresponding to the original sequence according to the total sequence length of the original sequence and the sequence parallelism scale.

The total sequence length is used for representing the total length of one original sequence, and the subsequence length is used for representing the total length of one subsequence. In some embodiments, the ratio of the total sequence length to the sequence parallelism scale may be used as the subsequence length. Generally speaking, the length of each subsequence in one communication group is the same.

In S230, the first processing device determines a sequence parallelism starting device index list according to a pre-acquired global device index list and the sequence parallelism scale.

The global device index list is used for representing the set of device indexes of all second processing devices included in one communication group, and the sequence parallelism starting device index list is used for representing the set of at least one device index of at least one first second processing device in at least one sequence parallelism group. The number of the device index included in the sequence parallelism starting device index list is equal to the number of the at least one sequence parallelism group included in the communication group. In some embodiments, the get_global_rank( ) function may be used to acquire the global device index list. The get_global_rank( ) function is an encapsulated function and is similar to an application programming interface (API). In some embodiments, the lower integer part of the ratio of the global device index list to the sequence parallelism scale is determined, the corresponding sequence parallelism starting device indexes are obtained according to the product value of the lower integer part and the sequence parallelism scale, and then all sequence parallelism starting device indexes are formed into the corresponding sequence parallelism starting device index list.

In S240, the first processing device divides the original sequence into the multiple subsequences according to the subsequence length.

In some embodiments, the first processing device divides the original sequence into multiple subsequences according to the subsequence length and the total sequence length of the original sequence, that is, the ratio of the total sequence length to the subsequence length is used as the number of subsequences; alternatively, the first processing device may directly divide the original sequence into the subsequences whose number is the same as the sequence parallelism scale, that is, each original sequence includes the subsequences whose number is the same as the sequence parallelism scale.

In S250, the first processing device transmits the subsequences to a target second processing device with a device index in the sequence parallelism starting device index list.

In some embodiments, there are multiple original sequence, for each original sequence, the first processing device may divide the original sequence into multiple subsequences, distribute and transmit the subsequences to a target second processing device with a device index in the sequence parallelism starting device index list, where the target second processing device with the device index may be the first second processing device in the sequence parallelism group which has a correspondence with the original sequence.

In S260, the target second processing device distributes and sends each of the multiple subsequences to a respective one of multiple second processing devices in the sequence parallelism group.

In some embodiments, the first second processing device may distribute and send the subsequences to second processing devices in the sequence parallelism group.

In S270, each second processing device determines a total query matrix, a total keyword matrix, and a total numerical matrix corresponding to the respective subsequence according to the subsequence and a query weight coefficient, keyword weight coefficient, and numerical weight coefficient corresponding to the subsequence.

In some embodiments, for each subsequence, the product value of the subsequence and the query weight coefficient corresponding to the subsequence may be used as the total query matrix corresponding to the subsequence; the product value of the subsequence and the keyword weight coefficient corresponding to the subsequence may be used as the total keyword matrix corresponding to the subsequence; and the product value of the subsequence and the numerical weight coefficient corresponding to the subsequence may be used as the total numerical matrix corresponding to the subsequence. For all subsequences, the number of total query matrices, the number of total keyword matrices, and the number of total numerical matrices calculated by the second processing devices corresponding to the all subsequences are each equal to the number of the all subsequences included in the original sequence. For example, if one original sequence is divided into T subsequences, the number of corresponding total query matrices, the number of corresponding total keyword matrices, and the number of corresponding total numerical matrices are each equal to T.

In S280, each second processing device determines an intra-card output matrix corresponding to the subsequence according to a product value of the total query matrix and the transpose of the total keyword matrix, a preconfigured mask matrix, and the total numerical matrix.

In some embodiments, for each subsequence, the second processing device calculates the product value of the total query matrix and the transpose of the total keyword matrix, performs the exclusive NOR (XNOR) operation of the product value and the preconfigured mask matrix to obtain the result of the XNOR operation, and multiplies the result of the XNOR operation by the total numerical matrix to obtain the intra-card output matrix corresponding to the subsequence.

In S290, each second processing device determines an inter-card output matrix corresponding to the subsequence according to the total query matrix, a preconfigured decay rate set, and a forward intermediate state of a previous subsequence.

The decay rate set refers to the decay rate diagonal matrix formed by the decay rate corresponding to each subsequence. It is to be noted that the number of decay rates included in the decay rate diagonal matrix is related to the subsequence length. For example, for each subsequence, if the subsequence length is C, then the decay rate diagonal matrix includes C decay rates, the first element on the decay rate diagonal matrix is λ, the second element is λ², . . . and the C-th element is λ^{C}. In some embodiments, the second processing device may first receive the forward intermediate state from the second processing device processing the previous subsequence and may save the forward intermediate state of the previous subsequence on the second processing device processing the previous subsequence as the forward intermediate state of the current subsequence through reverse calculation; and the second processing device then uses the product value of the total query matrix, the preconfigured decay rate set, and the forward intermediate state of the previous subsequence as the inter-card output matrix of the current subsequence.

In S2100, each second processing device determines the forward total output matrix corresponding to the subsequence according to the intra-card output matrix and the inter-card output matrix.

In some embodiments, for each subsequence, the second processing device adds the intra-card output matrix and the inter-card output matrix corresponding to the subsequence to obtain the forward total output matrix corresponding to the subsequence.

In S2110, each second processing device determines the gradient of an intra-card query matrix corresponding to the subsequence according to the gradient of the total output matrix, the transpose of the total numerical matrix, the preconfigured mask matrix, and the total keyword matrix.

In some embodiments, for each subsequence, the second processing device first determines the product value of the gradient of the total output matrix and the transpose of the total numerical matrix, then performs the XNOR operation of the product value and the preconfigured mask matrix to obtain a result of the XNOR operation, and multiplies the result of the XNOR operation by the total keyword matrix to obtain the gradient of the intra-card query matrix corresponding to the subsequence.

In S2120, each second processing device determines the gradient of an inter-card query matrix corresponding to the subsequence according to a preconfigured decay rate set, the gradient of the total output matrix, and a forward intermediate state of a previous subsequence.

For each subsequence, the decay rate set refers to the decay rate diagonal matrix formed by the decay rate corresponding to the subsequence. In some embodiments, the second processing device first uses the product value of the preconfigured decay rate set, the gradient of the total output matrix, and the forward intermediate state of the previous subsequence as the gradient of the inter-card query matrix corresponding to the subsequence.

In S2130, each second processing device determines the gradient of an intra-card keyword matrix corresponding to the subsequence according to the gradient of the total output matrix, the transpose of the total numerical matrix, the preconfigured mask matrix, and the total query matrix.

In some embodiments, for each subsequence, the second processing device multiplies the gradient of the total output matrix by the transpose of the total numerical matrix to obtain the corresponding matrix product value, performs the XNOR operation of the matrix product value and the preconfigured mask matrix, and multiplies the transpose of the result of the XNOR operation by the total query matrix to obtain the gradient of the intra-card keyword matrix corresponding to the subsequence.

In S2140, each second processing device determines the gradient of an intra-card numerical matrix corresponding to the subsequence according to the total query matrix, the transpose of the total keyword matrix, the preconfigured mask matrix, and the gradient of the total output matrix.

In some embodiments, for each subsequence, the second processing device multiplies the total query matrix by the transpose of the total keyword matrix to obtain the corresponding matrix product value, performs the XNOR operation of the matrix product value and the preconfigured mask matrix, and multiplies the transpose of the result of the XNOR operation by the gradient of the total output matrix to obtain the gradient of the intra-card numerical matrix corresponding to the subsequence.

In S2150, each second processing device determines the gradient of an inter-card keyword matrix corresponding to the subsequence according to the received reverse intermediate state of a next subsequence, an inverse matrix of the preconfigured decay rate set, a decay rate corresponding to the subsequence, and the total numerical matrix.

For each subsequence, the decay rate corresponding to the subsequence refers to the last element in the decay rate set, that is, λ^{C}. In some embodiments, the second processing device may receive the reverse intermediate state from the second processing device processing the next subsequence, calculate the product value of the inverse matrix of the decay rate set, λ^{C}, and the total numerical matrix, and then multiply the product value by the reverse intermediate state of the next subsequence to obtain the gradient of the inter-card keyword matrix corresponding to the subsequence.

In S2160, each second processing device determines the gradient of an inter-card numerical matrix corresponding to the subsequence according to the received reverse intermediate state of the next subsequence, the inverse matrix of the preconfigured decay rate set, the decay rate corresponding to the subsequence, and the total keyword matrix.

In some embodiments, for each subsequence, the decay rate corresponding to the subsequence refers to the last element in the decay rate set, that is, λ^{C}. In some embodiments, the second processing device may receive the reverse intermediate state from the second processing device processing the next subsequence, calculate the product value of the inverse matrix of the decay rate set, λ^{C}, and the total keyword matrix, and then multiply the product value by the reverse intermediate state of the next subsequence to obtain the gradient of the inter-card numerical matrix corresponding to the subsequence.

In S2170, each second processing device determines the gradient of the total query matrix corresponding to the subsequence according to the gradient of the intra-card query matrix and the gradient of the inter-card query matrix.

In some embodiments, for each subsequence, the second processing device may obtain the gradient of the total query matrix corresponding to the subsequence by adding the gradient of the intra-card query matrix and the gradient of the inter-card query matrix corresponding to the subsequence.

In S2180, each second processing device determines the gradient of the total keyword matrix corresponding to the subsequence according to the gradient of the intra-card keyword matrix and the gradient of the inter-card keyword matrix.

In some embodiments, for each subsequence, the second processing device may obtain the gradient of the total keyword matrix corresponding to the subsequence by adding the gradient of the intra-card keyword matrix and the gradient of the inter-card keyword matrix corresponding to the subsequence.

In S2190, each second processing device determines the gradient of the total numerical matrix corresponding to the subsequence according to the gradient of the intra-card numerical matrix and the gradient of the inter-card numerical matrix.

In some embodiments, for each subsequence, the second processing device may obtain the gradient of the total numerical matrix corresponding to the subsequence by adding the gradient of the intra-card numerical matrix and the gradient of the inter-card numerical matrix corresponding to the subsequence.

In some embodiments, the step of determining the forward total output matrix corresponding to the subsequence using the preconfigured forward propagation method further includes updating the forward intermediate state of the subsequence according to a product value of the forward intermediate state of the previous subsequence and a decay rate corresponding to the subsequence and a product value of the total numerical matrix and the transpose of a product value of an inverse matrix of a preconfigured decay rate set, a decay rate corresponding to the subsequence, and the total keyword matrix. In some embodiments, the decay rate corresponding to the subsequence refers to the last element in the decay rate set, that is, λ^{C}. The product value of the forward intermediate state of the previous subsequence and the decay rate corresponding to the subsequence is calculated as a first product value; the product value of the inverse matrix of the preconfigured decay rate set, the decay rate corresponding to the subsequence, and the total keyword matrix is calculated as a second product value; the transpose of the second product value is multiplied by the total numerical matrix to obtain a third product value; and the forward intermediate state of the current subsequence is updated using the sum of the first product value and the third product value.

In some embodiments, the linear attention sequence parallelism method further includes storing the forward intermediate state corresponding to each subsequence into a preset memory space of the second processing device. In some embodiments, to avoid recalculating the forward intermediate state KV in the backpropagation process, the forward intermediate state KV may be stored in the high bandwidth memory (HBM) of the GPU immediately after the forward propagation calculation. In the subsequent backpropagation process, LASP directly accesses KV for use. It is to be noted that the KV activation size stored in the HBM is d×d and is not affected by the total sequence length N of the original sequence. When the total sequence length N corresponding to the inputted original sequence is very long, the memory usage of KV becomes negligible.

In some embodiments, the step of determining the parameter gradient corresponding to the subsequence using the preconfigured backpropagation method and the forward total output matrix further includes updating the reverse intermediate state of the subsequence according to the reverse intermediate state of the next subsequence, the preconfigured decay rate and decay rate set, the total query matrix, and the gradient of the total output matrix. In some embodiments, the decay rate corresponding to the subsequence refers to the last element in the decay rate set, that is, λ^{C}. The product value of the reverse intermediate state of the next subsequence and the decay rate corresponding to the subsequence is calculated as a fourth product value; the product value of the preconfigured decay rate set and the total query matrix is calculated as a fifth product value; the transpose of the fifth product value is multiplied by the gradient of the total output matrix, so as to obtain a sixth product value; and the reverse intermediate state of the current subsequence is updated using the sum of the fourth product value and the sixth product value.

In some embodiments, LASP aims to train the long sequence on the linear transformer in the distributed environment by partitioning the input data along the sequence dimension. In this case, each GPU in the distributed environment assumes the training of the subsequence, thereby reducing the large memory footprint associated with activation when the long sequence is trained. The communication operation between GPUs is introduced to transmit the intermediate state. The final trained model absorbs the knowledge gained from the entire long sequence.

FIG. 4 is a flowchart illustrating the implementation of data distribution according to some embodiments of the present disclosure. It is to be noted that the data distribution process is performed by the first processing device, that is, the first processing device distributes the subsequences to the corresponding second processing devices.

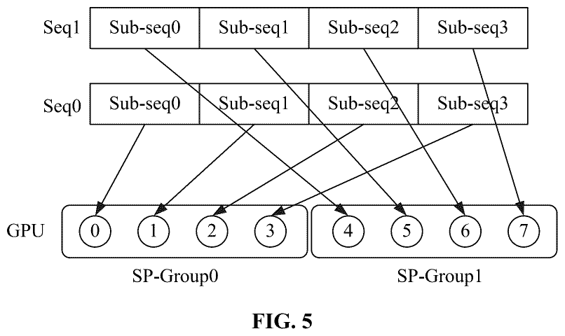

For an input sequence with a length of N, the embedding space representation is established, which is recorded as the original sequence X ∈ [symbol] \hat{ }{N×d}, where the feature dimension is d. In the LASP framework, the original sequence X is evenly divided into Tblocks, where T is referred to as the sequence parallelism size and must be evenly divisible by the distributed data size W. These divided data blocks are then allocated to corresponding GPUs. It is to be noted that different sequence parallelism groups receive different batches of data. That is to say, within a same sequence parallelism (SP) group, all data blocks come from the same batch of data. In LASP, for a detailed description of the data distribution process, reference is made to Algorithm 1. In addition, FIG. 5 is an example diagram of data distribution in LASP according to some embodiments of the present disclosure. A node with eight GPUs is considered, and two original sequences are each divided into four subsequence blocks.

In this example, the distributed world size is W=8, the sequence parallelism size is T=4, the number of sequence parallelism groups is G=2, and the sequence parallelism starting device index list is R_{src}=[0,4] (that is, the index of the first second processing device included in each of the two sequence parallelism groups, the index of the first second processing device included in the first sequence parallelism group is 0, and the index of the first second processing device included in the first sequence parallelism group is 4). For the first batch Seq0, the input original sequence X is divided into T blocks X_1,X_2, . . . . X_{T} along the sequence dimension, and then the Tblocks are transmitted to the first ranking (which corresponds to global ranking 0) in the first SP group (which is denoted as SP-Group0). Data blocks on the global ranking 0 are then distributed to global rankings 0, 1, 2, and 3 within SP-Group0, where only one block is retained for each global ranking. The subsequent batch Seq1 follows a similar allocation process and is allocated to global rankings 4, 5, 6, and 7 within SP-Group1.

As shown in FIG. 4, the data distribution process includes the steps described below.

In S410, the inputted original sequence X embedded in the spatial expression, the total sequence length N, the hidden dimension D, the number of distributed cards W, and the sequence parallelism scale T are inputted to the CPU.

In S420, the calculated number of sequence parallelism groups G is equal to W/T.

In S430, the calculated subsequence length C (or the block length) is equal to N/T.

In S440, the calculated global device index list R is acquired and is equal to get_global_rank()

In S450, the calculated sequence parallelism starting device index list R_src is equal to [R/T]*T.

In S460, the inputted X is divided into T subsequences along the sequence dimension: {X_1, X_2, . . . , X_T}.

In S470, the data subsequence {X_1, X_2, . . . , X_T} is transmitted to the corresponding second processing device index in R_src.

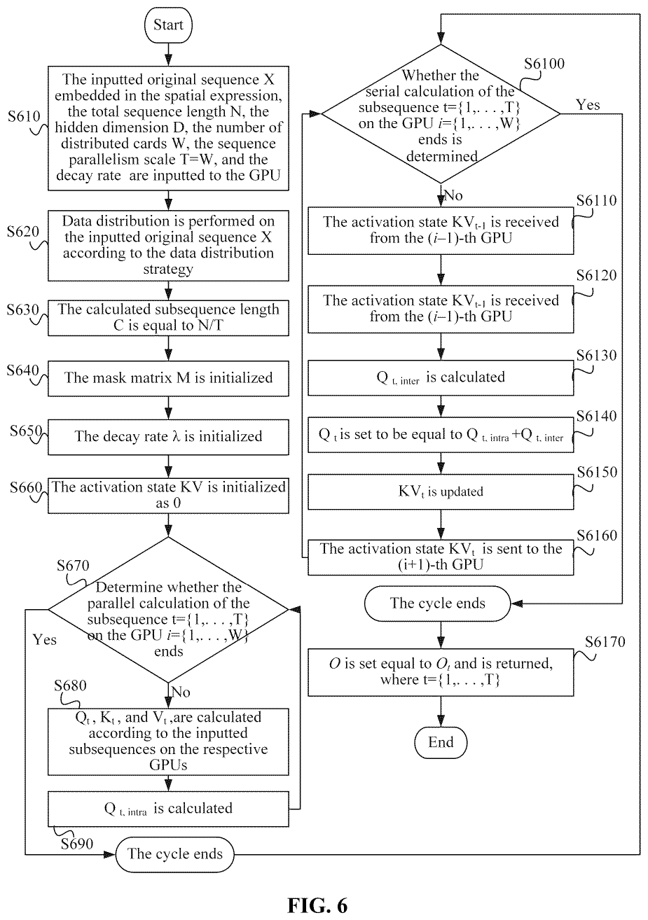

FIG. 6 is a flowchart illustrating the implementation of a forward propagation method according to some embodiments of the present disclosure. It is to be noted that the process of the forward propagation method is executed by the second processing device. As shown in FIG. 6, the implementation process of the forward propagation method includes the steps described below.

In S610, the inputted original sequence X embedded in the spatial expression, the total sequence length N, the hidden dimension D, the number of distributed cards W, the sequence parallelism scale T=W, and the decay rate λ are inputted to the GPU.

In S620, data distribution is performed on the inputted original sequence X according to the data distribution strategy.

In S630, the calculated subsequence length C is equal to N/T.

In S640, the mask matrix M is initialized.

In some embodiments, the mask matrix M ∈ [symbol] ^{C*C} is initialized. When i≥j, Mᵢⱼ=λ^{i-j}, otherwise Mᵢⱼ=0.

In S650, the decay rate λ is initialized.

In some embodiments, the decay rate set Λ=diag{λ, λ². . . λ^{C}}∈ [symbol] ^{C*C} is initialized, where C denotes the subsequence length, Λ denotes the decay rate set, and λ denotes the decay rate corresponding to each subsequence.

In S660, the activation state KV is initialized as 0.

In some embodiments, in the implementation process of the forward propagation method, the activation state KV may be understood as the forward intermediate state, and KV=0∈ [symbol] ^{d*d} is initialized, where d denotes the hidden dimension of [symbol] .

In S670, whether the parallel calculation of the subsequence t={1, . . . , T} on the GPU i={1, . . . , W} ends is determined. If so, the cycle ends; and if not, S680 is performed.

In S680, Qₜ, Kₜ, and Vₜ are calculated according to the inputted subsequences on the respective GPUs.

Qₜ=XₜW_{Q}, Kₜ=XₜW_{K}, and Vₜ=XₜW_{V}. Qₜ denotes the total query matrix corresponding to the t-th subsequence, Kₜ denotes the total keyword matrix corresponding to the t-th subsequence, Vₜ denotes the total numerical matrix corresponding to the t-th subsequence, Xₜ denotes the t-th subsequence, and W_{Q}, W_{K}, and W_{V} denote the query weight coefficient, the keyword weight coefficient, and the numerical weight coefficient, respectively.

In S690, O_{t, intra} is calculated.

O_{t, intra}=[QₜKₜ^{T} ⊙M]Vₜ, where O_{t, intra} denotes the intra-card output matrix corresponding to the t-th subsequence, Qₜ denotes the total query matrix corresponding to the t-th subsequence, Kₜ^{T} denotes the transpose of the total keyword matrix corresponding to the t-th subsequence, M denotes the preconfigured mask matrix, and Vₜ denotes the total numerical matrix corresponding to the t-th subsequence.

In S6100, whether the serial calculation of the subsequence t={1, . . . , T} on the GPU i={1, . . . , W} ends is determined. If so, the cycle ends; and if not, S6110 is performed.

In S6110, the activation state KVₜ₋₁ is received from the (i−1)-th GPU.

In S6120, KVₜ₋₁ is saved on the i-th GPU as KVᵢ through reverse calculation.

In S6130, O_{t, inter} is calculated.

In some embodiments, O_{t, inter}=ΛQₜKVₜ₋₁, where O_{t, inter} denotes the inter-card output matrix corresponding to the t-th subsequence, KVₜ₋₁ denotes the forward intermediate state corresponding to the (t−1)-th subsequence, and Qₜ denotes the total query matrix corresponding to the t-th subsequence.

In S6140, Oₜ is set to be equal to O_{t, intra}+O_{t, inter}.

Qₜ denotes the total output matrix of the t-th subsequence, O_{t, intra} denotes the intra-card output matrix of the t-th subsequence, and O_{t, inter} denotes the inter-card output matrix of the t-th subsequence.

In S6150, KVₜ is updated.

KVₜ=λ^{C}KVₜ₋₁+(λ^{C}Λ⁻¹KVₜ)Vₜ is updated, where KVₜ denotes the forward intermediate state corresponding to the t-th subsequence, KVₜ₋₁ denotes the forward intermediate state corresponding to the (t−1)-th subsequence, λ^{C} denotes the last element in the decay rate set, Λ⁻⁻¹ denotes the inverse matrix of the decay rate set, and V_t denotes the total numerical matrix corresponding to the t-th subsequence.

In S6160, the activation state KVₜ is sent to the (i+1)-th GPU.

In S6170, O is set equal to Oₜ and is returned, where t={1, . . . , T}.

O denotes the forward total output matrix, and Oₜ denotes the total output matrix of the t-th subsequence.

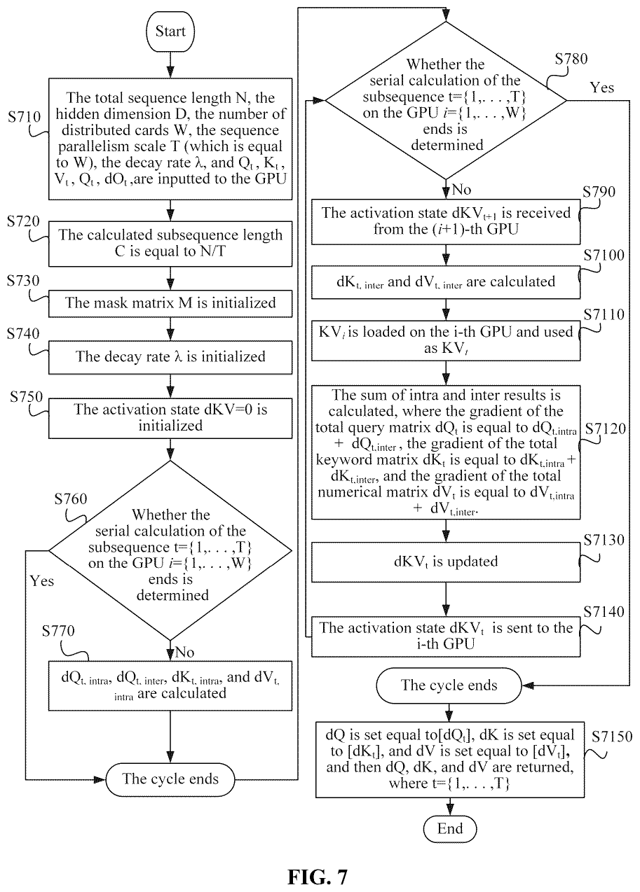

FIG. 7 is a flowchart illustrating the implementation of a backpropagation method according to some embodiments of the present disclosure. It is to be noted that the process of the backpropagation method is executed by the second processing device. As shown in FIG. 7, the implementation process of the backpropagation method includes the steps described below.

In S710, the total sequence length N, the hidden dimension D, the number of distributed cards W, the sequence parallelism scale T (which is equal to W), the decay rate λ, and Qₜ, Kₜ, Vₜ, Oₜ, dOₜ are inputted to the GPU.

λ∈ [symbol] ⁺, Qₜ, Kₜ, Vₜ, Oₜ, dOₜ∈ [symbol] ^{C×d}, where t∈{1,2, . . . , T}.

In S720, the calculated subsequence length C is equal to N/T.

In S730, the mask matrix M is initialized.

In some embodiments, the mask matrix M ∈ [symbol] ^{C*C} is initialized. When i≥j, Mᵢⱼ=λ^{i-j}, otherwise, Mᵢⱼ=0.

In S740, the decay rate λ is initialized.

In some embodiments, the decay rate set Λ=diag{λ, λ², . . . λ^{C}}∈ [symbol] ^{C*C} is initialized, where C denotes the subsequence length, Λ denotes the decay rate set, and λ denotes the decay rate corresponding to each subsequence.

In S750, the activation state dKV=0 is initialized.

In some embodiments, in the implementation process of the backpropagation method, the activation state dKV may be understood as the reverse intermediate state, and dKV=0∈ [symbol] ^{d*d} is initialized, where d denotes the hidden dimension of [symbol] .

In S760, whether the parallel calculation of the subsequence t={1, . . . , T} on the GPU i={1, . . . , W} ends is determined. If so, the cycle ends; and if not, S770 is performed.

In S770, dQ_{t, intra}, dQ_{t, inter}, dK_{t, intra}, and dV_{t,intra} are calculated.

dQ_{t, intra}=[(dOₜVₜ^{T}) ⊙ M]Kₜ, dQ_{t, inter}=ΛdOₜKVₜ₋₁, dK_{t, intra}=[(dOₜVₜ^{T}) ⊙ M]^{T} Qₜ, and dV_{t,intra}=[(QₜKₜ^{T}) ⊙ M]^{T}dOₜ. dQ_{t, intra} denotes the gradient of the intra-card query matrix corresponding to the t-th subsequence, dOₜ denotes the gradient of the total output matrix corresponding to the t-th subsequence, Qₜ denotes the total query matrix corresponding to the t-th subsequence, Kₜ₋₁^{T} denotes the transpose of the total keyword matrix corresponding to the (t−1)-th subsequence, K_{ty}^{T} denotes the transpose of the total keyword matrix corresponding to the t-th subsequence, Kₜ denotes the total keyword matrix corresponding to the t-th subsequence, M denotes the preconfigured mask matrix, Vₜ^{T} denotes the transpose of the total numerical matrix corresponding to the t-th subsequence, dQ_{t, inter} denotes the gradient of the inter-card query matrix corresponding to the t-th subsequence, dK_{t, intra} denotes the gradient of the intra-card keyword matrix corresponding to the t-th subsequence, dV_{t,intra} denotes the gradient of the intra-card numerical matrix corresponding to the t-th subsequence, and Λ denotes the decay rate set.

In S780, whether the serial calculation of the subsequence t={1, . . . , T} on the GPU i={1, . . . , W} ends is determined. If so, the cycle ends; and if not, S790 is performed.

In S790, the activation state dKVₜ₊₁ is received from the (i+1)-th GPU.

In S7100, dK_{t,inter} and dV_{t,inter} are calculated.

dK_{t,inter}=(λ^{C}Λ⁻¹Vₜ)dKVₜ₊₁^{T} and dV_{t,inter}=(λ^{C}Λ⁻¹Kₜ)dKVₜ₊₁. dKVₜ₊₁^{T} denotes the transpose of the reverse intermediate state corresponding to the (t+1)-th subsequence, dKVₜ₊₁ denotes the reverse intermediate state corresponding to the (t+1)-th subsequence, Λ⁻¹ denotes the inverse matrix of the decay rate set, Kₜ denotes the total keyword matrix corresponding to the t-th subsequence, λ^{C} denotes the last element in the decay rate set, and Vₜ denotes the total numerical matrix corresponding to the t-th subsequence.

In S7110, KVᵢ is loaded on the i-th GPU and used as KVₜ.

In S7120, the sum of intra and inter results is calculated, where the gradient of the total query matrix dQₜ corresponding to the t-th subsequence is equal to dQ_{t, intra}+dQ_{t, inter}, the gradient of the total keyword matrix dKₜ corresponding to the t-th subsequence is equal to dK_{t, intra}+dK_{t, inter}, and the gradient of the total numerical matrix dVₜ corresponding to the t-th subsequence is equal to dV_{t, intra}+dV_{t, inter}.

In S7130, dKVₜ is updated.

dKVₜ=λ^{C}dKVₜ₊₁+(ΛQₜ)^{T}dOₜ, where dKVₜ denotes the reverse intermediate state corresponding to the t-th subsequence, dKVₜ₊₁ denotes the reverse intermediate state corresponding to the (i+1)-th subsequence, dOₜ denotes the gradient of the total output matrix corresponding to the t-th subsequence, λ^{C} denotes the last element in the decay rate set, Qₜ denotes the total query matrix corresponding to the t-th subsequence, and Λ denotes the decay rate set.

In S7140, the activation state dKVₜ is sent to the i-th GPU.

In S7150, dQ is set equal to [dQₜ], dK is set equal to [dKₜ], and dV is set equal to [dVₜ], and then dQ, dK, and dV are returned, where t∈{1,2, . . . , T}.

When the LASP algorithm is examined, forward propagation requires to be noted, and communication of the KV activation is required on each linear attention module layer. The communication volume is determined by Bd²/h, where B denotes the batch size, and h denotes the number of heads. In comparison, the sequence parallelism scheme in Megatron-LM adopts two All-Reduce operations after two Layer-Norm layers in each transformer layer and adopts one Reduce-Scatter operation after the attention layer and the feed forward network (FFN) layer, resulting in a communication volume of 2BNd+4BNd/T. DeepSpeed adopts an all-to-all set communication operation to process the input Q, K, and V and the output O of each attention module layer, resulting in a communication volume of 4BNd/T.

Table 1 shows the comparison result of the communication volumes of three frameworks. d/h denotes the head dimension and is generally set to 128. In practical applications, when N/T≥32, LASP can achieve the lowest theoretical communication volume. Furthermore, the communication volume of LASP is not affected by changes in the sequence length N or the subsequence length C, which is a huge advantage for parallelizing extremely long sequences across large GPU clusters.

TABLE 1
Comparison table of communication volumes obtained
by different implementation frameworks

| Implementation | Complete | Simplified |
|---|---|---|
| framework | formula | formula |
| LASP | Bd²/h | d/h |
| DeepSpeed-Ulysses | 4BNd/T | 4N/T |
| Megatron-SP | 2BNd + 4BNd/T | 2Nd + 4N/T |

As shown in Table 1, the simplified formulas in the last column represent the calculation results after Bd is eliminated. Megatron-SP refers to Megatron-LM sequence parallelism.

Kernel fusion: to improve the efficiency of LASP on the GPU, kernel fusion is performed on both intra-block and cross-block calculations, and the updates of KV and dKV are fused into intra-block and cross-block calculations.

KV state caching: to avoid recalculating and activating KV in the backpropagation process, KV may be stored in the HBM of the GPU immediately after the forward propagation calculation. In the subsequent backpropagation process, LASP directly accesses KV for use. It is to be noted that the KV activation size stored in the HBM is d×d and is not affected by the sequence length N. When the input sequence length N is very long, the memory usage of KV becomes negligible.

The data parallelism technique is generally used for dividing input data along the batch dimension in large-scale distributed deep learning. However, LASP takes a different approach, partitioning the data along the sequence dimension, which makes it easier to integrate with the data parallelism technique. As described in the data distribution chapter and illustrated in FIG. 2, LASP allows specifying a relatively small sequence parallelism size that is evenly divisible by the distributed world size. This configuration results in the input data being divided along batch and sequence dimensions, which is a hybrid parallelism type referred to as data sequence hybrid parallelism.

As an important distributed training technology, the sharded data parallel method aims to reduce the GPU memory usage during large model training. The ZeRO in DeepSpeed and FSDP in PyTorch propose a method for distributing model states (including the optimizer states, the gradients, and the model parameters) to all GPUs in the distributed environment. The strategic distribution significantly reduces the memory utilization on a single GPU. As variations of the data parallelism technique, these techniques fit perfectly with LASP. However, this greater focus on minimizing the memory footprint of the model state complements LASP's goal of reducing the activated memory on each GPU. By combining these methods, training a large model with a large sequence length becomes more feasible.

The LASP proposed by the embodiment of the present disclosure effectively solves the limitations of the existing SP method on the linear transformer by fully utilizing the specific characteristics of linear attention, thereby significantly improving the parallelism efficiency and usability of the linear attention model. By implementing an efficient point-to-point communication mechanism and engineering optimizations such as kernel fusion and KV state caching, LASP achieves significant reductions in the communication volume and improves hardware utilization of the GPU cluster. Compatibility with various types of batch-level DDP methods ensures the practicality of LASP in large-scale distributed training. Moreover, the experimental results in Table 1 highlight the advantages of LASP in terms of scalability, speed, memory usage, and convergence performance on the linear transformer, and the comparison with existing SP methods in an out-of-the-box framework is made.

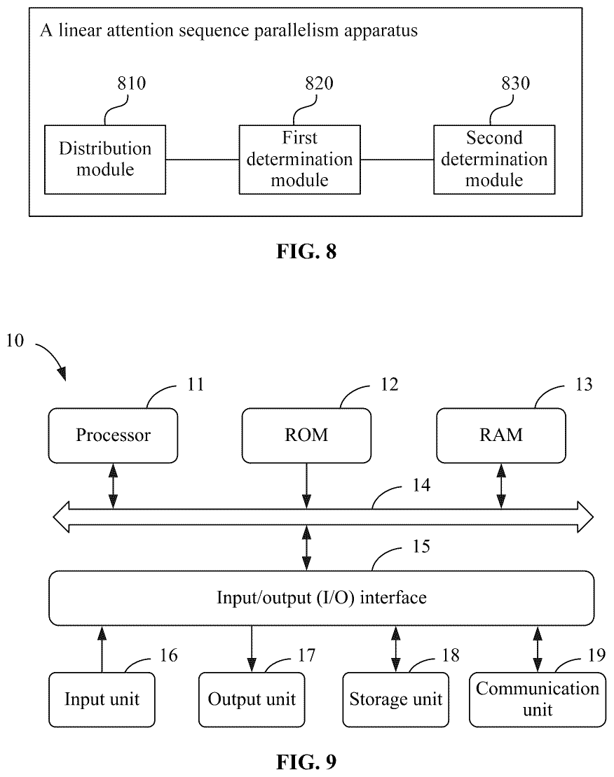

FIG. 8 is a structural diagram of a linear attention sequence parallelism apparatus according to some embodiments of the present disclosure. As shown in FIG. 8, the apparatus includes a distribution module 810, a first determination module 820, and a second determination module 830.

The distribution module 810 is configured in a first processing device and a second processing device and to distribute multiple subsequences corresponding to an original sequence on a linear transformer in a distributed environment to corresponding second processing devices according to a preconfigured data distribution strategy.

The first determination module 820 is configured in a second processing device and to determine a forward total output matrix corresponding to a subsequence of the multiple subsequences using a preconfigured forward propagation method.

The second determination module 830 is configured in the second processing device and to determine a parameter gradient corresponding to the subsequence according to a preconfigured backpropagation method and the forward total output matrix and configured to update parameters corresponding to the subsequence according to the parameter gradient.

In some embodiments, the distribution module 810 includes a first determination unit, a second determination unit, a third determination unit, a division unit, a transmission unit, and a distribution unit.

The first determination unit is configured in the first processing device and to determine the number of at least one sequence parallelism group according to the number of preconfigured distributed cards and the sequence parallelism scale.

The second determination unit is configured in the first processing device and to determine the subsequence length corresponding to the original sequence according to the total sequence length of the original sequence and the sequence parallelism scale.

The third determination unit is configured in the first processing device and to determine a sequence parallelism starting device index list according to a pre-acquired global device index list and the sequence parallelism scale.

The division unit is configured in the first processing device and to divide the original sequence into the multiple subsequences according to the subsequence length.

The transmission unit is configured in the first processing device and to transmit the subsequences to a target second processing device with an index in the sequence parallelism starting device index list.

The distribution unit is configured in the target second processing device and to distribute and send each subsequence to a respective second processing device in a sequence parallelism group corresponding to the original sequence.

In some embodiments, the first determination module 820 includes a first determination unit, a second determination unit, a third determination unit, and a fourth determination unit.

The first determination unit is configured to determine a total query matrix, a total keyword matrix, and a total numerical matrix corresponding to the subsequence according to the subsequence and a query weight coefficient, keyword weight coefficient, and numerical weight coefficient corresponding to the subsequence.

The second determination unit is configured to determine an intra-card output matrix corresponding to the subsequence according to a product value of the total query matrix and the transpose of the total keyword matrix, a preconfigured mask matrix, and the total numerical matrix.

The third determination unit is configured to determine an inter-card output matrix corresponding to the subsequence according to the total query matrix, a preconfigured decay rate set, and a forward intermediate state of a previous subsequence.

The fourth determination unit is configured to determine the forward total output matrix corresponding to the subsequence according to the intra-card output matrix and the inter-card output matrix.

In some embodiments, the first determination module further includes an updating unit.

The updating unit is configured to update the forward intermediate state of the subsequence according to a product value of the forward intermediate state of the previous subsequence and a decay rate corresponding to the subsequence and a product value of a transpose of a product value of an inverse matrix of a preconfigured decay rate set, a decay rate corresponding to the subsequence, and the total keyword matrix and the total numerical matrix.

In some embodiments, the linear attention sequence parallelism apparatus further includes a storage module.

A storage module is configured to store the forward intermediate state corresponding to each subsequence into the preset memory space of the second processing device.

In some embodiments, the second determination module includes a first determination unit, a second determination unit, a third determination unit, a fourth determination unit, a fifth determination unit, a sixth determination unit, a seventh determination unit, an eighth determination unit, and a ninth determination unit.

The first determination unit is configured to determine the gradient of an intra-card query matrix corresponding to the subsequence according to the gradient of the total output matrix, the transpose of the total numerical matrix, the preconfigured mask matrix, and the total keyword matrix.

The second determination unit is configured to determine the gradient of an inter-card query matrix corresponding to the subsequence according to a preconfigured decay rate set, the gradient of the total output matrix, and a forward intermediate state of a previous subsequence.

The third determination unit is configured to determine the gradient of an intra-card keyword matrix corresponding to the subsequence according to the gradient of the total output matrix, the transpose of the total numerical matrix, the preconfigured mask matrix, and the total query matrix.

The fourth determination unit is configured to determine the gradient of an intra-card numerical matrix corresponding to the subsequence according to the total query matrix, the transpose of the total keyword matrix, the preconfigured mask matrix, and the gradient of the total output matrix.

The fifth determination unit is configured to determine the gradient of an inter-card keyword matrix corresponding to the subsequence according to the received reverse intermediate state of a next subsequence, an inverse matrix of the preconfigured decay rate set, a decay rate corresponding to the subsequence, and the total numerical matrix.

The sixth determination unit is configured to determine the gradient of an inter-card numerical matrix corresponding to the subsequence according to the received reverse intermediate state of the next subsequence, the inverse matrix of the preconfigured decay rate set, the decay rate corresponding to the subsequence, and the total keyword matrix.

The seventh determination unit is configured to determine the gradient of the corresponding total query matrix according to the gradient of the intra-card query matrix and the gradient of the inter-card query matrix.

The eighth determination unit is configured to determine the gradient of the corresponding total keyword matrix according to the gradient of the intra-card keyword matrix and the gradient of the inter-card keyword matrix.

The ninth determination unit is configured to determine the gradient of the corresponding total numerical matrix according to the gradient of the intra-card numerical matrix and the gradient of the inter-card numerical matrix.

In some embodiments, an updating unit is further included.

The updating unit is configured to update the reverse intermediate state of the subsequence according to the reverse intermediate state of the next subsequence, a preconfigured decay rate and decay rate set, the total query matrix, and the gradient of the total output matrix.

The linear attention sequence parallelism apparatus provided in the embodiment of the present disclosure may perform the linear attention sequence parallelism method provided in any embodiment of the present disclosure and has function modules and beneficial effects corresponding to the performed method.

FIG. 9 is a block diagram of an electronic device according to some embodiments of the present disclosure. FIG. 9 shows a structural diagram of an electronic device 10 that can be used to implement the embodiments of the present disclosure. The electronic device is intended to represent various forms of digital computers, for example, a laptop computer, a desktop computer, a worktable, a personal digital assistant, a server, a blade server, a mainframe computer, or another applicable computer. The electronic device may also represent various forms of mobile apparatuses, for example, a personal digital assistant, a cellphone, a smartphone, a wearable device (such as a helmet, glasses, and a watch), or another similar computing apparatus. Herein the shown components, the connections and relationships between these components, and the functions of these components are illustrative only and are not intended to limit the implementation of the present disclosure as described and/or claimed herein.

As shown in FIG. 9, the electronic device 10 includes at least one processor 11 and a memory (such as a read-only memory (ROM) 12 and a random-access memory (RAM) 13) communicatively connected to the at least one processor 11. The memory stores a computer program executable by the at least one processor. The processor 11 may perform various types of appropriate operations and processing according to a computer program stored in the ROM 12 or a computer program loaded from a storage unit 18 to the RAM 13. Various programs and data required for the operation of the electronic device 10 are also stored in the RAM 13. The processor 11, the ROM 12, and the RAM 13 are connected to each other through a bus 14. An input/output (I/O) interface 15 is also connected to the bus 14.

Multiple components in the electronic device 10 are connected to the I/O interface 15. The multiple components include an input unit 16 such as a keyboard or a mouse, an output unit 17 such as various types of displays or speakers, the storage unit 18 such as a magnetic disk or an optical disc, and a communication unit 19 such as a network card, a modem or a wireless communication transceiver. The communication unit 19 allows the electronic device 10 to exchange information/data with other devices over a computer network such as the Internet and/or various telecommunications networks.

The processor 11 may be various general-purpose and/or special-purpose processing components having processing and computing capabilities. Examples of the processor 11 include, but are not limited to, a central processing unit (CPU), a graphics processing unit (GPU), a special-purpose artificial intelligence (AI) computing chip, a processor executing machine learning models and algorithms, a digital signal processor (DSP), and any appropriate processor, controller, and microcontroller. The processor 11 performs various methods and processing described above, such as the linear attention sequence parallelism method.

In some embodiments, the linear attention sequence parallelism method may be implemented as computer programs tangibly contained in a computer-readable storage medium such as the storage unit 18. In some embodiments, part or all of computer programs may be loaded and/or installed onto the electronic device 10 via the ROM 12 and/or the communication unit 19. When the computer programs are loaded to the RAM 13 and executed by the processor 11, one or more steps of the preceding linear attention sequence parallelism method may be performed. Alternatively, in other embodiments, the processor 11 may be configured, in any other suitable manner (for example, by means of firmware), to perform the linear attention sequence parallelism method.

Herein various embodiments of the preceding systems and techniques may be implemented in digital electronic circuitry, integrated circuitry, field-programmable gate arrays (FPGAs), application-specific integrated circuits (ASICs), application-specific standard products (ASSPs), systems on chips (SoCs), complex programmable logic devices (CPLDs), computer hardware, firmware, software, and/or combinations thereof. These embodiments may include implementations in one or more computer programs. The one or more computer programs may be executable and/or interpretable on a programmable system including at least one programmable processor. A programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Computer programs for implementation of the methods of the present disclosure may be written in one programming language or any combination of multiple programming languages. These computer programs may be provided for a processor of a general-purpose computer, a special-purpose computer, or another programmable data processing apparatus such that the computer programs, when executed by the processor, cause functions/operations specified in the flowcharts and/or block diagrams to be implemented. These computer programs may be executed entirely on a machine, partly on a machine, as a stand-alone software package partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus, or device. The computer-readable storage medium may include, but is not limited to, an electronic, magnetic, optical, electromagnetic, infrared, or semiconductor system, apparatus, or device or any appropriate combination thereof. Alternatively, the computer-readable storage medium may be a machine-readable signal medium. Concrete examples of the machine-readable storage medium include an electrical connection based on one or more wires, a portable computer disk, a hard disk, a random-access memory (RAM), a read-only memory (ROM), an erasable programmable read-only memory (EPROM), a flash memory, an optical fiber, a portable compact disc read-only memory (CD-ROM), an optical storage device, a magnetic storage device or any suitable combination thereof.

In order that interaction with a user is provided, the systems and techniques described herein may be implemented on the electronic device. The electronic device has a display device (for example, a cathode-ray tube (CRT) or a liquid-crystal display (LCD) monitor) for displaying information to the user; and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related VPS service.

It is to be understood that various forms of the preceding flows may be used with steps reordered, added, or deleted. For example, the steps described in the present disclosure may be performed in parallel, in sequence, or in a different order as long as the desired result of the technical solutions provided in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement, and the like made within the spirit and principle of the present disclosure fall within the scope of the present disclosure.

What is claimed is:

1. A linear attention sequence parallelism method, comprising:
distributing, by a first processing device, each of a plurality of subsequences corresponding to an original sequence on a linear transformer in a distributed environment to a respective one of a plurality of second processing devices according to a preconfigured data distribution strategy;
determining, by the respective second processing device, a respective one of a plurality of forward total output matrices corresponding to each subsequence according to a preconfigured forward propagation manner; and
determining, by the respective second processing device, a respective one of a plurality of parameter gradients corresponding to each subsequence according to a preconfigured backpropagation manner and the forward total output matrix, and updating a parameter corresponding to each subsequence according to the respective parameter gradient.

2. The method of claim 1, wherein distributing, by a first processing device, each of the plurality of subsequences corresponding to the original sequence on the linear transformer in the distributed environment to the respective second processing device according to the preconfigured data distribution strategy comprises:
determining, by a first processing device, a number of at least one sequence parallelism group according to a number of preconfigured distributed cards and a sequence parallelism scale;
determining, by a first processing device, a subsequence length corresponding to the original sequence according to a total sequence length of the original sequence and the sequence parallelism scale;
determining, by a first processing device, a sequence parallelism starting device index list according to a pre-acquired global device index list and the sequence parallelism scale;
dividing, by a first processing device, the original sequence into the plurality of subsequences according to the subsequence length;
transmitting, by a first processing device, the plurality of subsequences to a target second processing device with a device index in the sequence parallelism starting device index list; and
distributing and sending, by the target second processing device, the plurality of subsequences to second processing devices in one of the at least one sequence parallelism group corresponding to the original sequence.

3. The method of claim 1, wherein determining the respective forward total output matrix corresponding to each subsequence according to the preconfigured forward propagation manner comprises:
determining a total query matrix, a total keyword matrix, and a total numerical matrix corresponding to the subsequence according to the subsequence and a query weight coefficient, keyword weight coefficient, and numerical weight coefficient corresponding to the subsequence;
determining an intra-card output matrix corresponding to the subsequence according to a product value of the total query matrix and a transpose of the total keyword matrix, a preconfigured mask matrix, and the total numerical matrix;
determining an inter-card output matrix corresponding to the subsequence according to the total query matrix, a preconfigured decay rate diagonal matrix, and a forward intermediate state of a previous subsequence; and
determining the respective forward total output matrix corresponding to the subsequence according to the intra-card output matrix and the inter-card output matrix.

4. The method of claim 3, wherein determining the respective forward total output matrix corresponding to each subsequence according to the preconfigured forward propagation manner further comprises:
updating the forward intermediate state of the subsequence according to a product value of the forward intermediate state of the previous subsequence and a decay rate corresponding to the subsequence and a product value of a transpose of a product value of an inverse matrix of a preconfigured decay rate set, a decay rate corresponding to the subsequence, and the total keyword matrix and the total numerical matrix.

5. The method of claim 3, further comprising:
storing the forward intermediate state corresponding to each of the plurality of subsequences into a preset memory space of the second processing device.

6. The method of claim 1, wherein,
the parameter gradient comprises: a gradient of a total query matrix, a gradient of a total keyword matrix, and a gradient of a total numerical matrix; and
determining the respective parameter gradient corresponding to each subsequence according to the preconfigured backpropagation manner and the forward total output matrix comprises:
determining a gradient of an intra-card query matrix corresponding to the subsequence according to a gradient of the total output matrix, a transpose of the total numerical matrix, a preconfigured mask matrix, and the total keyword matrix;
determining a gradient of an inter-card query matrix corresponding to the subsequence according to a preconfigured decay rate set, the gradient of the total output matrix, and a forward intermediate state of a previous subsequence;
determining a gradient of an intra-card keyword matrix corresponding to the subsequence according to the gradient of the total output matrix, the transpose of the total numerical matrix, the preconfigured mask matrix, and the total query matrix;
determining a gradient of an intra-card numerical matrix corresponding to the subsequence according to the total query matrix, a transpose of the total keyword matrix, the preconfigured mask matrix, and the gradient of the total output matrix;
determining a gradient of an inter-card keyword matrix corresponding to the subsequence according to a received reverse intermediate state of a next subsequence, an inverse matrix of the preconfigured decay rate set, a decay rate corresponding to the subsequence, and the total numerical matrix;
determining a gradient of an inter-card numerical matrix corresponding to the subsequence according to the received reverse intermediate state of the next subsequence, the inverse matrix of the preconfigured decay rate set, the decay rate corresponding to the subsequence, and the total keyword matrix;
determining the gradient of the corresponding total query matrix according to the gradient of the intra-card query matrix and the gradient of the inter-card query matrix;
determining the gradient of the corresponding total keyword matrix according to the gradient of the intra-card keyword matrix and the gradient of the inter-card keyword matrix; and
determining the gradient of the corresponding total numerical matrix according to the gradient of the intra-card numerical matrix and the gradient of the inter-card numerical matrix.

7. The method of claim 6, wherein determining the respective parameter gradient corresponding to each subsequence according to the preconfigured backpropagation manner and the forward total output matrix further comprises:
updating the reverse intermediate state of the subsequence according to the reverse intermediate state of the next subsequence, a preconfigured decay rate and decay rate set, the total query matrix, and the gradient of the total output matrix.

8. An electronic device, comprising:
at least one processor; and
a memory communicatively connected to the at least one processor; wherein
wherein the memory stores a computer program executable by the at least one processor to enable:
the at least one processor in a first processing device and a second processing device to distribute each of a plurality of subsequences corresponding to an original sequence on a linear transformer in a distributed environment to a respective one of a plurality of second processing devices according to a preconfigured data distribution strategy;
the at least one processor in the respective second processing device to determine a respective one of a plurality of forward total output matrices corresponding to each subsequence according to a preconfigured forward propagation manner, and determine a respective one of a plurality of parameter gradients corresponding to each subsequence according to a preconfigured backpropagation manner and the forward total output matrix, and updating a parameter corresponding to each subsequence according to the respective parameter gradient.

9. The electronic device of claim 8, wherein the at least one processor is configured to distribute each of the plurality of subsequences corresponding to the original sequence on the linear transformer in the distributed environment to the respective second processing device according to the preconfigured data distribution strategy by:
determining a number of at least one sequence parallelism group according to a number of preconfigured distributed cards and a sequence parallelism scale;
determining a subsequence length corresponding to the original sequence according to a total sequence length of the original sequence and the sequence parallelism scale;
determining a sequence parallelism starting device index list according to a pre-acquired global device index list and the sequence parallelism scale;
dividing the original sequence into the plurality of subsequences according to the subsequence length;
transmitting the plurality of subsequences to a target second processing device with a device index in the sequence parallelism starting device index list; and
distributing and sending the plurality of subsequences to second processing devices in one of the at least one sequence parallelism group corresponding to the original sequence.

10. The electronic device of claim 8, wherein the at least one processor is configured to determine the respective forward total output matrix corresponding to each subsequence according to the preconfigured forward propagation manner by:
determining a total query matrix, a total keyword matrix, and a total numerical matrix corresponding to the subsequence according to the subsequence and a query weight coefficient, keyword weight coefficient, and numerical weight coefficient corresponding to the subsequence;
determining an intra-card output matrix corresponding to the subsequence according to a product value of the total query matrix and a transpose of the total keyword matrix, a preconfigured mask matrix, and the total numerical matrix;
determining an inter-card output matrix corresponding to the subsequence according to the total query matrix, a preconfigured decay rate diagonal matrix, and a forward intermediate state of a previous subsequence; and
determining the respective forward total output matrix corresponding to the subsequence according to the intra-card output matrix and the inter-card output matrix.

11. The electronic device of claim 10, wherein the at least one processor is configured to determine the respective forward total output matrix corresponding to each subsequence according to the preconfigured forward propagation manner further by:
updating the forward intermediate state of the subsequence according to a product value of the forward intermediate state of the previous subsequence and a decay rate corresponding to the subsequence and a product value of a transpose of a product value of an inverse matrix of a preconfigured decay rate set, a decay rate corresponding to the subsequence, and the total keyword matrix and the total numerical matrix.

12. The electronic device of claim 10, wherein the at least one processor is further configured to store the forward intermediate state corresponding to each of the plurality of subsequences into a preset memory space of the second processing device.

13. The electronic device of claim 8, wherein, the parameter gradient comprises: a gradient of a total query matrix, a gradient of a total keyword matrix, and a gradient of a total numerical matrix; and
the at least one processor is configured to determine the respective parameter gradient corresponding to each subsequence according to the preconfigured backpropagation manner and the forward total output matrix by:
determining a gradient of an intra-card query matrix corresponding to the subsequence according to a gradient of the total output matrix, a transpose of the total numerical matrix, a preconfigured mask matrix, and the total keyword matrix;
determining a gradient of an inter-card query matrix corresponding to the subsequence according to a preconfigured decay rate set, the gradient of the total output matrix, and a forward intermediate state of a previous subsequence;
determining a gradient of an intra-card keyword matrix corresponding to the subsequence according to the gradient of the total output matrix, the transpose of the total numerical matrix, the preconfigured mask matrix, and the total query matrix;
determining a gradient of an intra-card numerical matrix corresponding to the subsequence according to the total query matrix, a transpose of the total keyword matrix, the preconfigured mask matrix, and the gradient of the total output matrix;
determining a gradient of an inter-card keyword matrix corresponding to the subsequence according to a received reverse intermediate state of a next subsequence, an inverse matrix of the preconfigured decay rate set, a decay rate corresponding to the subsequence, and the total numerical matrix;
determining a gradient of an inter-card numerical matrix corresponding to the subsequence according to the received reverse intermediate state of the next subsequence, the inverse matrix of the preconfigured decay rate set, the decay rate corresponding to the subsequence, and the total keyword matrix;
determining the gradient of the corresponding total query matrix according to the gradient of the intra-card query matrix and the gradient of the inter-card query matrix;
determining the gradient of the corresponding total keyword matrix according to the gradient of the intra-card keyword matrix and the gradient of the inter-card keyword matrix; and
determining the gradient of the corresponding total numerical matrix according to the gradient of the intra-card numerical matrix and the gradient of the inter-card numerical matrix.

14. The electronic device of claim 13, wherein the at least one processor is configured to determine the respective parameter gradient corresponding to each subsequence according to the preconfigured backpropagation manner and the forward total output matrix by:
updating the reverse intermediate state of the subsequence according to the reverse intermediate state of the next subsequence, a preconfigured decay rate and decay rate set, the total query matrix, and the gradient of the total output matrix.

15. A non-transitory computer-readable storage medium storing computer instructions configured to, when executed by a processor, cause:
the processor in a first processing device and a second processing device to distribute each of a plurality of subsequences corresponding to an original sequence on a linear transformer in a distributed environment to a respective one of a plurality of second processing devices according to a preconfigured data distribution strategy;
the processor in the respective second processing device to determine a respective one of a plurality of forward total output matrices corresponding to each subsequence according to a preconfigured forward propagation manner, and determine a respective one of a plurality of parameter gradients corresponding to each subsequence according to a preconfigured backpropagation manner and the forward total output matrix, and updating a parameter corresponding to each subsequence according to the respective parameter gradient.

16. The non-transitory computer-readable storage medium of claim 15, wherein the processor is configured to distribute each of the plurality of subsequences corresponding to the original sequence on the linear transformer in the distributed environment to the respective second processing device according to the preconfigured data distribution strategy by:
determining a number of at least one sequence parallelism group according to a number of preconfigured distributed cards and a sequence parallelism scale;
determining a subsequence length corresponding to the original sequence according to a total sequence length of the original sequence and the sequence parallelism scale;
determining a sequence parallelism starting device index list according to a pre-acquired global device index list and the sequence parallelism scale;
dividing the original sequence into the plurality of subsequences according to the subsequence length;
transmitting the plurality of subsequences to a target second processing device with a device index in the sequence parallelism starting device index list; and
distributing and sending the plurality of subsequences to second processing devices in one of the at least one sequence parallelism group corresponding to the original sequence.

17. The non-transitory computer-readable storage medium of claim 15, wherein the processor is configured to determine the respective forward total output matrix corresponding to each subsequence according to the preconfigured forward propagation manner by:
determining a total query matrix, a total keyword matrix, and a total numerical matrix corresponding to the subsequence according to the subsequence and a query weight coefficient, keyword weight coefficient, and numerical weight coefficient corresponding to the subsequence;
determining an intra-card output matrix corresponding to the subsequence according to a product value of the total query matrix and a transpose of the total keyword matrix, a preconfigured mask matrix, and the total numerical matrix;
determining an inter-card output matrix corresponding to the subsequence according to the total query matrix, a preconfigured decay rate diagonal matrix, and a forward intermediate state of a previous subsequence; and
determining the respective forward total output matrix corresponding to the subsequence according to the intra-card output matrix and the inter-card output matrix.

18. The non-transitory computer-readable storage medium of claim 17, wherein the processor is configured to determine the respective forward total output matrix corresponding to each subsequence according to the preconfigured forward propagation manner further by:
updating the forward intermediate state of the subsequence according to a product value of the forward intermediate state of the previous subsequence and a decay rate corresponding to the subsequence and a product value of a transpose of a product value of an inverse matrix of a preconfigured decay rate set, a decay rate corresponding to the subsequence, and the total keyword matrix and the total numerical matrix.

19. The non-transitory computer-readable storage medium of claim 17, wherein the processor is further configured to store the forward intermediate state corresponding to each of the plurality of subsequences into a preset memory space of the second processing device.

20. The non-transitory computer-readable storage medium of claim 15, wherein,
the parameter gradient comprises: a gradient of a total query matrix, a gradient of a total keyword matrix, and a gradient of a total numerical matrix; and
the processor is configured to determine the respective parameter gradient corresponding to each subsequence according to the preconfigured backpropagation manner and the forward total output matrix by:
determining a gradient of an intra-card query matrix corresponding to the subsequence according to a gradient of the total output matrix, a transpose of the total numerical matrix, a preconfigured mask matrix, and the total keyword matrix;
determining a gradient of an inter-card query matrix corresponding to the subsequence according to a preconfigured decay rate set, the gradient of the total output matrix, and a forward intermediate state of a previous subsequence;
determining a gradient of an intra-card keyword matrix corresponding to the subsequence according to the gradient of the total output matrix, the transpose of the total numerical matrix, the preconfigured mask matrix, and the total query matrix;
determining a gradient of an intra-card numerical matrix corresponding to the subsequence according to the total query matrix, a transpose of the total keyword matrix, the preconfigured mask matrix, and the gradient of the total output matrix;
determining a gradient of an inter-card keyword matrix corresponding to the subsequence according to a received reverse intermediate state of a next subsequence, an inverse matrix of the preconfigured decay rate set, a decay rate corresponding to the subsequence, and the total numerical matrix;
determining a gradient of an inter-card numerical matrix corresponding to the subsequence according to the received reverse intermediate state of the next subsequence, the inverse matrix of the preconfigured decay rate set, the decay rate corresponding to the subsequence, and the total keyword matrix;
determining the gradient of the corresponding total query matrix according to the gradient of the intra-card query matrix and the gradient of the inter-card query matrix;
determining the gradient of the corresponding total keyword matrix according to the gradient of the intra-card keyword matrix and the gradient of the inter-card keyword matrix; and
determining the gradient of the corresponding total numerical matrix according to the gradient of the intra-card numerical matrix and the gradient of the inter-card numerical matrix.
